(19) United States
(12) Patent Application Publication
(10) Pub. No.: US 2013/0073461 A1
(43) Pub. Date: Mar. 21, 2013

(54) Processing a Payment Transaction Involving a Merchant Account and a Customer Account Associated with the Same Enterprise

(71) Applicants: Mark D. Zanzot, Huntersville, NC (US); Christopher R. Griggs, Fort Mill, SC (US); David T. Frew, Fort Mill, SC (US); Tony England, Tega Cay, SC (US); Lisa Gibson, Newnan, GA (US)

(72) Inventors: Mark D. Zanzot, Huntersville, NC (US); Christopher R. Griggs, Fort Mill, SC (US); David T. Frew, Fort Mill, SC (US); Tony England, Tega Cay, SC (US); Lisa Gibson, Newnan, GA (US)

(73) Assignee: Bank of America Corporation, Charlotte, NC (US)

(21) Appl. No.: 13/235,823

(22) Filed: Sep. 19, 2011

(51) Int. Cl. G06Q 40/00

(52) U.S. Cl. 705/44

(57) ABSTRACT

In an exemplary embodiment, a method includes receiving a payment transaction comprising a customer account identifier and a merchant account identifier. A processor may determine whether the customer account identifier and merchant account identifier correspond to respective accounts associated with the enterprise. If the account identifiers each correspond to a respective account associated with the enterprise, the processing of the payment transaction is initiated at the enterprise and a notification that the enterprise initiates the processing of the payment transaction is sent. If the account identifiers do not each correspond to a respective account associated with the enterprise, a notification that the payment transaction was not processed may be sent.

### TECHNICAL FIELD OF THE INVENTION

This invention relates generally to payment processing and, more specifically, to processing a payment transaction involving a merchant account and a customer account associated with the same enterprise.

### BACKGROUND OF THE INVENTION

Customers purchase goods and services from merchants. Customers may pay for purchases with funds available in a customer account associated with the customer. A particular payment transaction may be associated with the customer account and a merchant account associated with a merchant. The payment transaction may be processed by transferring funds from the customer account to the merchant account using third party payment mechanisms.

### SUMMARY OF THE INVENTION

In accordance with the teachings of the present disclosure, disadvantages and problems associated with processing payment transactions may be reduced or eliminated.

According to an exemplary embodiment, a method includes receiving, at an enterprise from a network, a payment transaction comprising a customer account identifier and a merchant account identifier. A processor may determine whether the customer account identifier corresponds to a customer account associated with the enterprise. The processor may also determine whether the merchant account identifier corresponds to a merchant account associated with the enterprise. If the customer account identifier and the merchant account identifier each correspond to a respective account associated with the enterprise, the processing of the payment transaction may be initiated at the enterprise and a notification that the enterprise initiates the processing of the payment transaction may be sent. If the customer account identifier and the merchant account identifier do not each correspond to a respective account associated with the enterprise, a notification that the payment transaction was not processed may be sent.

Certain embodiments of the invention may provide one or more technical advantages. A technical advantage of one embodiment includes using a payment transaction module to determine whether a customer account and a merchant account involved in a payment transaction are associated with the same enterprise. Another advantage includes initiating, at an enterprise, payment processing for a payment transaction if the merchant account and customer account involved in the payment transaction are both associated with the enterprise. Another advantage includes using a method of alternative payment processing that is more efficient and cost effective than a default payment processing method.

Certain embodiments of the present disclosure may include none, some, or all of the above technical advantages. One or more other technical advantages may be readily apparent to one skilled in the art in view of the figures, descriptions, and claims of the present disclosure.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example system that facilitates processing a payment transaction involving a merchant account and a customer account associated with the same enterprise;

FIG. 2 illustrates a particular embodiment of a payment transaction module of the system of FIG. 1;

FIG. 3 illustrates a particular embodiment of a mobile payment application module of the system of FIG. 1;

FIG. 4 illustrates an example method for facilitating the processing of a payment transaction involving a merchant account and a customer account associated with the same enterprise; and

FIG. 5 illustrates an example method for facilitating the processing of a payment transaction originating from a mobile device.

### DETAILED DESCRIPTION OF THE INVENTION

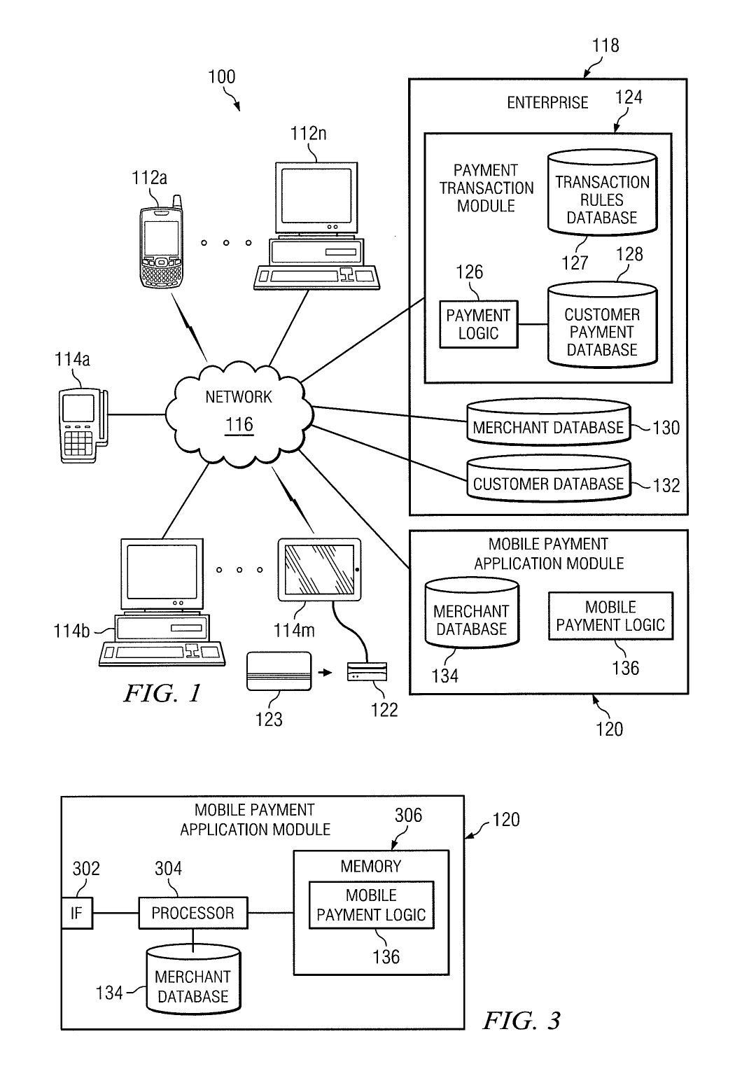

Embodiments of the present invention and its advantages are best understood by referring to FIGS. 1 through 5, like numerals being used for like and corresponding parts of the various drawings.

FIG. 1 illustrates an example system 100 that facilitates processing a payment transaction involving a merchant account and a customer account associated with the same enterprise 118. System 100 includes one or more computers 112 and one or more payment devices 114 that communicate over one or more networks 116 with enterprise 118 and/or mobile payment application module 120 to facilitate payment processing of a payment transaction between a customer and a merchant.

System 100 includes computers 112a-112n, where n represents any suitable number, that communicate with payment devices 114a-m or enterprise 118 through network 116. Computer 112 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 100. Computer 112 may also comprise a user interface, such as a display, keyboard, mouse, or other appropriate terminal equipment.

Computer 112 may be operated by a customer. Computer 112 may communicate with payment devices 114 or enterprise 118 through network 116. A customer may use computer 112 to set up an account with enterprise 118 and/or change account preferences. The customer may also use other suitable means (e.g., telephone or paperwork) to perform these operations. An account may be a credit card account, a savings account, a debit card account, a checking account, or any other account. An account may be associated with enterprise 118. For example, enterprise 118 may maintain the account, store records of transactions involving the account, transfer money to and from the account, or perform other operations associated with the account. An account may enable a customer to purchase goods or services from merchants with funds or credit associated with the customer's account. In some embodiments, users may also use computer 112 to communicate with payment devices 114 to purchase goods or services from merchants.

Payment devices 114a-114m, where m represents any suitable number, may communicate with computers 112a-112n, enterprise 118, and/or mobile payment application module 120 through network 116 to facilitate the processing of payment transactions. Payment device 114 may include a web server, a mainframe, a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 100. Payment device 114 may also comprise a user interface, such as a display, keyboard, mouse, or other appropriate terminal equipment.

In some embodiments, payment device 114m is a mobile device that is portable and connects to network 116 via a wireless connection, such as a cellular connection. For example, payment device 114m may be a smartphone, netbook, notebook, tablet, or slate personal computer. In some embodiments, payment device 114m is operable to be coupled to a card reading apparatus 122 via a port, such as an audio or universal serial bus (USB) port. Payment device 114m may be operable to receive a payment transaction that is initiated by a customer swiping card 123 through a card reading apparatus 122.

Payment device 114 may be associated with a merchant. For example, payment device 114 may be owned, operated, and/or controlled by a merchant. A merchant is an entity in any suitable industry that conducts a transaction with a customer. A merchant may include a retailer, a wholesaler, a service company, or any other suitable entity that has customers and conducts transactions with the customers. A transaction may be a payment transaction that includes receiving payment for goods or services from the customer or crediting a refund to the customer. A merchant may use payment device 114 to accept payment from a customer.

In some embodiments, a customer may use a payment module (e.g., card 123) to pay for a transaction. The payment module may be operable to provide an identity of an account of the customer to a payment device 114 associated with a merchant. The payment module may be any suitable medium for communicating the identity of the account of the customer to the payment device 114. For example, a payment module may be a credit card, debit card, check card, radio frequency identification (RFID) tag, software application, webpage, electronic data, or other suitable medium. A payment module may communicate the identity of the account to payment device 114 using any suitable method, such as the swiping of a card through a card reading device in communication with payment device 114, a transmission of the customer account identifier to the payment device 114 (using wired or wireless connections), a manual submission of the customer account identifier into payment device 114 (e.g., a merchant may key a number associated with the payment module into payment device 114), or other suitable method.

In some situations, a payment module may be associated with a payment processing entity. A payment processing entity may control a payment network that is normally used for payment processing (i.e., a default payment network) when a payment module associated with the payment processing entity is used in a payment transaction. Payment processing may refer to the process of receiving funds from the customer account and sending funds to the merchant account. For example, after receiving a payment transaction, the default payment network may communicate with the enterprise associated with the customer account to acquire funds. The default payment network then transfers these funds to the merchant account via the enterprise associated with the merchant account. For purposes of illustration, a payment processing entity may be named Company and may own and/or control a payment network called Companynetwork. Company may manage a line of debit cards. In this example, Companynetwork is typically used for payment processing when a Company debit card is swiped at payment device 114a. A payment transaction may be received at payment device 114a and routed to Companynetwork through network 116. Companynetwork performs the transfer of funds between the enterprises associated with the accounts involved in the transaction. For example, when a customer makes a purchase, the enterprise associated with the customer account may transfer funds to Companynetwork and the enterprise associated with the merchant account may receive funds from Companynetwork (and vice versa for a payment refund).

In various embodiments, an alternative method of payment processing is performed if a customer account and a merchant account involved in a payment transaction are each associated with the same enterprise 118. Alternative payment processing may refer to payment processing by a processing entity that is different from the default network. In particular embodiments, alternative payment processing includes bypassing a default payment network that is normally used for payment processing. For example, a transaction involving a Company debit card may bypass Companynetwork and be performed by an alternative processing entity. Alternative payment processing may result in more efficient and cost effective processing of a payment transaction. In some embodiments, alternative payment processing may include application of one or more discounts, one or more cash back amounts, and/or one or more benefits. Alternative payment processing is described in more detail below in connection with payment transaction module 124.

Network 116 represents any suitable network operable to facilitate communication between the components of system 100, such as computers 112, payment devices 114, enterprise 118, and mobile payment application module 120. Network 116 may include any interconnecting system capable of transmitting audio, video, signals, data, messages, or any combination of the preceding. Network 116 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Enterprise 118 may represent any individual, business, or organization. One example of an enterprise may include a financial institution. A financial institution may include any individual, business, or organization that engages in financial activities, which may include, but are not limited to, banking and investment activities such as maintaining accounts (e.g., transaction accounts, savings accounts, credit accounts, investment accounts, insurance accounts, portfolios, etc.), receiving deposits, crediting accounts, debiting accounts, extending credit to account holders, purchasing securities, providing insurance, and supervising a customer's portfolio.

A financial institution may provide a variety of financial products and services. Examples of financial products and services may include, but are not limited to, account services such as maintaining accounts, receiving deposits, crediting accounts, debiting accounts, extending credit, purchasing securities, providing insurance, and portfolio management.

A financial institution may provide financial products and services to customers. For example, a financial institution may maintain an account for a customer. The customer may perform a variety of activities using the account, including contributing funds to the account, withdrawing funds from the account, managing the account, and being responsible or liable for account transactions (e.g., purchases).

In some embodiments, enterprise 118 may represent one or more financial institutions, such as a bank, that communicates with computers 112, payment devices 114, and/or mobile payment application module 120 to facilitate alternative payment processing. In some embodiments, enterprise 118 comprises a group of financial institutions that process a payment transaction in a similar manner if the customer account and the merchant account involved in the transaction are each associated with (e.g., maintained by) a financial institution of the group. That is, if the customer account is associated with a financial institution of the group and the merchant account is also associated with a financial institution of the group (which may or may not be the same financial institution), then alternative payment processing is performed.

Payment transaction module 124 represents any suitable components that facilitate the operation of enterprise 118 by facilitating communication with computers 112, payment devices 114, and/or mobile payment application module 120 and facilitating alternative payment processing when appropriate. Payment transaction module 124 may include a network server, any suitable remote server, a mainframe, a host computer, a workstation, a web server, a personal computer, a file server, or any other suitable device operable to communicate with computers 112, payment devices 114, and/or mobile payment application module 120 and process data. In some embodiments, payment transaction module 124 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of payment transaction module 124 may be performed by any suitable combination of one or more servers or other components at one or more locations. In the embodiment where payment transaction module 124 is a server, the server may be a private server, and the server may be a virtual or physical server. The server may include one or more servers at the same or remote locations. Also, payment transaction module 124 may include any suitable component that functions as a server.

In some embodiments, payment transaction module 124 may receive a payment transaction between a customer and a merchant. The payment transaction may include a customer account identifier and a merchant account identifier. In some embodiments, payment transaction module 124 accesses merchant database 130 to determine whether the merchant account identifier identifies a merchant account associated with enterprise 118. In some embodiments, payment transaction module 124 may access customer database 132 to determine whether the customer account identifier identifies a customer account associated with enterprise 118.

If both accounts involved in the payment transaction are associated with the enterprise 118, payment transaction module 124 may facilitate alternative payment processing. In some embodiments, payment transaction module 124 may access transaction rules database 127 and/or customer payment database 128 to determine one or more payment transaction rules that apply to the payment transaction. For example, the payment transaction rules may indicate a particular alternative processing entity that will process the payment transaction, a discount or amount of cash back that applies to the payment transaction, a benefit associated with the payment transaction, or other suitable rule.

Once the payment transaction rules have been determined, payment transaction module 124 may initiate the payment transaction, such that the payment transaction is processed according to the payment transaction rules. In some embodiments, payment transaction module 124 may cause the enterprise 118 to process the payment transaction by communicating with one or more modules (e.g., merchant database 130 and/or customer database 132) of enterprise 118 to debit the customer's account and credit the merchant's account according to the payment transaction rules. In some embodiments, enterprise 118 may process the payment transaction by performing a book transfer. A book transfer is a direct transfer (i.e., general ledger) transfer of funds from the relevant customer account at enterprise 118 to the relevant merchant account at enterprise 118. In some embodiments, a book transfer may be an internal transfer within enterprise 118. That is, the book transfer may be accomplished within enterprise 118 without utilizing an outside network.

In other embodiments, payment transaction module 124 may initiate the payment transaction by causing an alternative processing entity that is different from enterprise 118 to process the payment transaction. For example, payment transaction module 124 may communicate the payment transaction, any information included in the payment transaction, and/or applicable payment transaction rules to the alternative processing entity that will process the transaction, so that the payment may be processed according to the payment transaction rules. The payment transaction module 124 may communicate with the alternative processing entity in any suitable manner, such as directly, or through mobile payment application module 120, network 116, and/or payment device 114. After payment transaction module 124 has communicated the payment transaction rules to the alternative processing entity, the payment transaction may be processed by the alternative processing entity according to the payment transaction rules. The alternative processing entity may be any suitable individual, organization, component, or group of components (e.g., a network) that is operable to process payment transactions. In a particular embodiment, the alternative processing entity is enterprise 118. In another embodiment, the alternative processing entity is the Automated Clearinghouse (ACH) Network described below in greater detail.

In some embodiments, if either the customer account or the merchant account is not associated with the enterprise, payment transaction module 124 generates a message indicating that the payment transaction was not processed and sends this message to payment device 114, mobile payment application module 120, and/or network 116 so that normal payment processing may be performed. In various embodiments, a message, notification, or instruction sent to network 116 may include transmission to a component of network 116, such as a device that acts as an intermediary for payment device 114 to facilitate payment processing.

In the illustrated embodiment, payment transaction module 124 includes payment logic 126. Payment logic 126 generally refers to logic, rules, algorithms, code, tables, and/or other suitable instructions embodied in a computer-readable storage medium for performing the described functions and operations of payment transaction module 124.

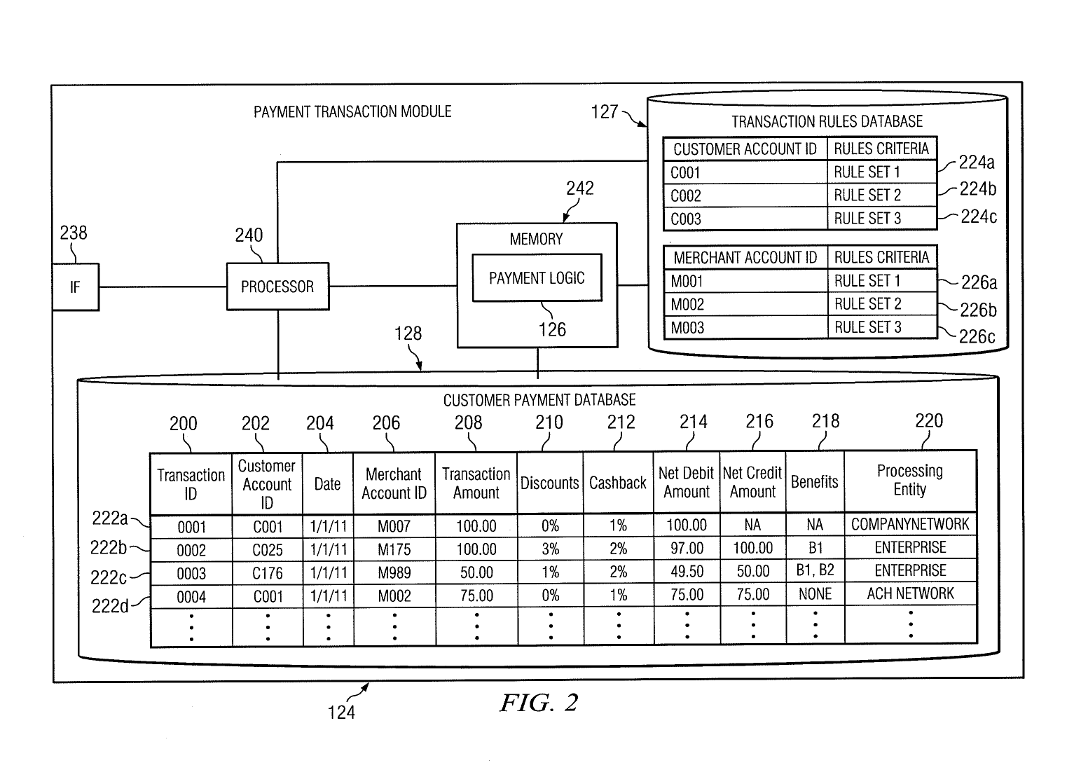

In the illustrated embodiment, payment transaction module 124 includes transaction rules database 127. Transaction rules database 127 stores, either permanently or temporarily, payment transaction rules for transactions that take place between customers and merchants that each have accounts associated with enterprise 118. Transaction rules database 127 includes any one or a combination of volatile or non-volatile local or remote devices suitable for storing information. For example, transaction rules database 127 may include RAM, ROM, magnetic storage devices, optical storage devices, or any other suitable information storage device or combination of these devices. Transaction rules database 127 will be described in greater detail in FIG. 2.

In the illustrated embodiment, payment transaction module 124 further includes customer payment database 128. Customer payment database 128 stores, either permanently or temporarily, payment transaction records for customers that have accounts associated with (e.g., maintained by) enterprise 118. Customers that have accounts with enterprise 118 conduct payment transactions with merchants and the payment transaction records are stored in customer payment database 128. Customer payment database 128 includes any one or a combination of volatile or non-volatile local or remote devices suitable for storing information. For example, customer payment database 128 may include RAM, ROM, magnetic storage devices, optical storage devices, or any other suitable information storage device or combination of these devices. Customer payment database 128 will be described in greater detail in FIG. 2.

Merchant database 130 stores, either permanently or temporarily, account information for merchants that have accounts associated with enterprise 118. In some embodiments, merchant database 130 stores identifying information for each merchant account associated with enterprise 118. For example, merchant database 130 may store a plurality of merchant account identifiers that each identify a particular merchant account associated with enterprise 118. A merchant account identifier may be any suitable identification means, such a numeric, alphabetical, alphanumeric, or symbolic value. Merchant database 130 may also store other account information, such as account balances for the merchant accounts. Merchant database 130 includes any one or a combination of volatile or non-volatile local or remote devices suitable for storing information. For example, merchant database may include RAM, ROM, magnetic storage devices, optical storage devices, or any other suitable information storage device or combination of these devices.

Customer database 132 stores, either permanently or temporarily, account information for customers that have accounts associated with enterprise 118. In some embodiments, customer database 132 stores identifying information for each customer account associated with enterprise 118. For example, customer database 132 may store a plurality of customer account identifiers that each identify a particular customer account associated with enterprise 118. A customer account identifier may be any suitable identification means, such a numeric, alphabetical, alphanumeric, or symbolic value. Customer database 132 may also store other account information, such as account balances for the customer accounts. Customer database 132 includes any one or a combination of volatile or non-volatile local or remote devices suitable for storing information. For example, customer database 132 may include RAM, ROM, magnetic storage devices, optical storage devices, or any other suitable information storage device or combination of these devices.

Mobile payment application module 120 represents any suitable component that facilitates communication with payment devices 114, network 116, and enterprise 118 and facilitates alternative payment processing. Mobile payment application module 120 may include a network server, any suitable remote server, a mainframe, a host computer, a workstation, a web server, a personal computer, a file server, or any other suitable device operable to communicate with payment devices 114, network 116, and/or enterprise 118 and process data. In some embodiments, mobile payment application module 120 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of mobile payment application module 120 may be performed by any suitable combination of one or more servers or other components at one or more locations. In the embodiment where mobile payment application module 120 is a server, the server may be a private server, and the server may be a virtual or physical server. The server may include one or more servers at the same or remote locations. In some embodiments, mobile payment application module 120 may include any suitable component that functions as a server.

Mobile payment application module 120 may be operable to receive a payment transaction originating from a mobile device, such as payment device 114m. The payment transaction may be initiated in any suitable manner. For example, the payment transaction may be initiated by a customer swiping a card 123 through card reading apparatus 122 coupled to payment device 114m. As another example, a merchant associated with payment device 114m may manually enter a customer account identifier into payment device 114m. As another example, a customer may use computer 112 to submit a customer account identifier to payment device 114m. In particular embodiments, mobile payment application module 120 may receive the payment transaction from payment device 114m through an entity that facilitates payment processing on behalf of a plurality of mobile devices that each use a card reading apparatus similar to (e.g., of the same brand as) card reading apparatus 122.

After receiving the payment transaction, the mobile payment application module 120 may determine a customer account identifier and a merchant account identifier of the payment transaction. In some embodiments, mobile payment application module 120 may communicate the merchant account identifier to enterprise 118 for use by the enterprise in determining whether the merchant account identifier corresponds to a merchant account associated with enterprise 118. In other embodiments, mobile payment application module 120 may determine whether the merchant account identifier corresponds to a merchant account associated with enterprise 118. For example, mobile payment application module 120 may access a database to determine whether the merchant account identifier corresponds to a merchant account associated with enterprise 118.

If some embodiments, if the merchant account does not correspond to a merchant account associated with enterprise 118, mobile payment application module 120 sends a notification to payment device 114m, network 116, and/or enterprise 118 that the payment transaction was not processed. The payment transaction may then undergo normal payment processing by a default network. In some embodiments, if the merchant account does not correspond to a merchant account associated with enterprise 118, mobile payment application module 120 does not communicate information included in the payment transaction to enterprise 118. For example, mobile payment application module 120 may decide that alternative payment processing is not applicable and thus does not need to communicate further with enterprise 118.

In some embodiments, the mobile payment application module 120 may communicate the customer account identifier to enterprise 118 for use by the enterprise in determining whether the customer account identifier corresponds to a customer account associated with enterprise 118. As mentioned above, mobile payment application module 120 may also communicate the merchant account identifier or an indication of whether the merchant account identifier corresponds to a merchant account associated with enterprise 118.

After communicating the customer account identifier and the merchant account identifier (or an indication of whether the merchant account is associated with enterprise 118) to enterprise 118, mobile payment application module 120 may receive an indication from enterprise 118 that enterprise 118 initiates processing of the payment transaction. For example, mobile payment application module 120 may receive an indication that enterprise 118 will process (or already has processed) the payment transaction. As another example, mobile payment application module 120 may receive an indication that enterprise 118 has instructed (or will instruct) an alternative processing entity to process the payment transaction. As another example, enterprise 118 may instruct mobile payment application module 120 to instruct an alternative processing entity to process the payment transaction.

If enterprise 118 instructs mobile payment application module 120 to instruct an alternative processing entity to process the payment transaction, mobile payment application may also receive one or more payment transaction rules for processing the payment transaction from enterprise 118. In some embodiments, mobile payment application module 120 may communicate the payment transaction and/or the one or more payment transaction rules to the alternative processing entity. In some embodiments, mobile payment application module 120 may communicate the payment transaction and/or the one or more payment transaction rules to the payment device 114m and/or network 116. In various embodiments, payment device 114m or network 116 may then send the payment transaction and/or payment transaction rules to the alternative processing entity.

In some embodiments, once mobile payment application module 120 learns that the payment transaction has been processed (or that the processing has been initiated by enterprise 118), it may communicate this information to network 116 and/or payment device 114m. Thus, after receiving this information, payment device 114m or another device that is facilitating payment processing on behalf of payment device 114m may then perform any suitable post-processing actions, and the payment transaction is completed. Mobile payment application module 120 will be described in greater detail in connection with FIG. 3.

A component of system 100 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 100 without departing from the scope of the invention. For example, enterprise 118 may include mobile payment application module 120. Additionally, system 100 may include any number of computers 112, payment devices 114, networks 116, enterprises 118, and mobile payment application modules 120. Any suitable logic may perform the functions of system 100 and the components within system 100.

In operation, enterprise 118 is operable to receive, from network 116, a payment transaction comprising a customer account identifier and a merchant account identifier. Payment transaction module 124 of enterprise 118 is operable to determine whether the customer account identifier corresponds to a customer account associated with the enterprise and whether the merchant account identifier corresponds to a merchant account associated with the enterprise 118. If the customer account identifier and the merchant account identifier each correspond to a respective account associated with the enterprise 118, the processing of the payment transaction is initiated at the enterprise 118.

In operation, mobile payment application module 120 is operable to receive, from a mobile device, a payment transaction between a customer and a merchant. Mobile payment application module 120 is operable to determine a customer account identifier and a merchant account identifier of the payment transaction. If the customer account identifier and the merchant account identifier each correspond to a respective account associated with the enterprise 118, the mobile payment application module 120 sends a notification that the payment transaction was processed.

FIG. 2 illustrates an example embodiment of payment transaction module 124. Payment transaction module 124 includes one or more interfaces 238, one or more processors 240, one or more memories 242, transaction rules database 127, and customer payment database 128 that collectively facilitate alternative payment processing of a payment transaction.

Network interface 238 represents any suitable device operable to receive information from network 116, transmit information through network 116, perform processing of information, communicate with other devices, or any combination of the preceding. For example, network interface 238 receives payment transactions involving customer accounts and merchant accounts. As another example, network interface 238 may communicate payment transaction results (e.g., whether a payment transaction was processed) and payment transaction rules to mobile payment application module 120, network 116, and/or payment devices 114. As another example, network interface 238 may communicate with computers 112 when customers set up or update an account. Network interface 238 represents any port or connection, real or virtual, including any suitable hardware and/or software, including protocol conversion and data processing capabilities, to communicate through a LAN, WAN, or other communication system that allows enterprise 118 to exchange information with network 116, computers 112, payment devices 114, or other components of system 100.

Processor 240 communicatively couples to network interface 238, memory 242, transaction rules database 127, and customer payment database 128, and controls the operation and administration of payment transaction module 124 by processing information received from network interface 238, memory 242, transaction rules database 127, and customer payment database 128. Processor 240 includes any hardware and/or software that operates to control and process information. For example, processor 240 executes payment logic 126 to control the operation of payment transaction module 124. Processor 240 may be a programmable logic device, a microcontroller, a microprocessor, any suitable processing device, or any suitable combination of the preceding.

Memory 242 stores, either permanently or temporarily, data, operational software, or other information for processor 240. Memory 242 includes any one or a combination of volatile or non-volatile local or remote devices suitable for storing information. For example, memory 242 may include RAM, ROM, magnetic storage devices, optical storage devices, or any other suitable information storage device or a combination of these devices. In the illustrated embodiment, memory 242 includes payment logic 126. As described above, payment logic 126 represents any suitable set of instructions, logic, or code embodied in a computer-readable storage medium and operable to facilitate the operation of payment transaction module 124. While illustrated as including a particular module, memory 242 may include any suitable information for use in the operation of payment transaction module 124.

In the illustrated embodiment, payment transaction module 124 includes a transaction rules database 127 that stores rule sets 224 and 226. Rule sets 224 and 226 comprise information that indicates how to process a particular payment transaction. As depicted, rule set 224 may be associated with a customer account via a customer account identifier and a rule set 226 may be associated with a merchant account via a merchant account identifier. Rule set 224 may include criteria for determining rules applicable for a payment transaction involving the associated customer account. Rule set 226 may include criteria for determining rules applicable for a payment transaction involving the associated merchant account In some embodiments, payment transaction module 124 may use information included in a payment transaction and rule set 224 and/or rule set 226 to determine the applicable payment transaction rules for the payment transaction. In some embodiments, payment transaction module 224 may access transaction rules database 127 to determine which payment transaction rules are applicable to a payment transaction. In particular embodiments, payment transaction module 124 may access rules set 224 associated with the customer account identifier and/or rules set 226 associated with the merchant account identifier of the payment transaction to determine which payment transaction rules are applicable. In some embodiments, determining the payment transaction rules may also include accessing transactions 122 in customer payment database 128. For example, a particular payment transaction rule (such as a discount or cash back amount) may be dependent on a volume of past transactions that may be determined by analyzing data from transactions 122.

Any suitable payment transaction rules may be determined by the payment transaction module 127. Payment transaction rules may include payment entity rules, cash back rules, discount rules, benefit rules, or other suitable rules. A payment entity rule may indicate an alternative processing entity through which the payment transaction is to be processed. In some embodiments, possible values of a payment entity rule include enterprise 118 and ACH network. The ACH network is a network that processes large amounts of credit and debit transactions in batches. In some embodiments, the method of payment processing in the ACH network is defined at least in part by rules set forth by the National Automated Clearing House Association (NACHA).

A cash back rule defines an amount of cash back that a customer receives from a payment transaction. This value may be expressed in any suitable manner, such as a numerical value or a percentage. In some embodiments, this value is dependent on the value of the payment entity rule. In particular embodiments, the cash back amount may be applied to the customer account at the time of payment processing. In other embodiments, the customer account may be credited for the cash back amount at a later time.

A discount rule defines a discount applicable to a payment transaction. The value may be expressed in any suitable manner, such as a numerical value or a percentage. In some embodiments, the discount is dependent on the value of the payment entity rule. This discount may be applied before or after the cash back amount is applied. The discount decreases the amount the customer account is debited and may or may not decrease the amount the merchant account is credited.

A benefit rule defines benefits that apply to the payment transaction. As an example, enterprise 118 may provide purchase insurance for transactions conducted between its customers and merchants. As another example, a certain number of transactions or accumulated transaction amounts may qualify the customer account or merchant account for certain account benefits, such as a waiver of account fees. Qualifying payment transactions may be indicated as such with the benefit rule.

After the payment transaction rules applicable to a payment transaction are determined by payment transaction module 124, the payment transaction may be recorded in customer payment database 128. In some embodiments, payment transaction module 124 may wait for an indication that the transaction was successfully processed before recording the payment transaction in customer payment database 128.

In the illustrated embodiment, payment transaction module 124 includes a customer payment database 128 that stores payment transaction records 222. Customer payment database 128 may be stored in payment transaction module 124 or may be stored in an external network storage device. Customer payment database 128 is operable to store each transaction involving a customer account associated with enterprise 118. Customers that have a credit card account, a checking account, a savings account, a debit card account, or other account may have transactions stored within customer payment database 128. The transactions may be stored in an organized manner within customer payment database 128. In an embodiment, customer payment database 128 is organized by payment transaction records 222. Each payment transaction record 222 may have any suitable number of fields to represent the transaction.

In certain embodiments, payment transaction record 222 may include some or all of the following fields depicted in FIG. 2: transaction identifier field 200, customer account identifier field 202, date field 204, merchant account identifier field 206, transaction amount field 208, discount field 210, cash back field 212, net debit amount field 214, net credit amount field 216, benefits field 218, and payment entity field 220. Transaction identifier field 200 represents an identifier of a particular transaction. The transaction may be with any suitable merchant. Customer identifier field 202 represents a unique or non-unique identifier of a customer. Date field 204 represents the date on which the transaction occurred. The value in merchant account identifier field 206 represents an identifier of the merchant account involved in the transaction. Transaction amount field 208 includes the gross amount of the transaction. Discount field 210 includes a discount that applies to the transaction. Cash back field 212 includes a cash back amount that applies to the transaction. Net debit amount field 214 represents the amount that the customer account was debited for the transaction. Net credit amount field 216 represents the amount that the merchant account was credited for the transaction. Benefits field 218 includes benefits that apply to the transaction. Payment entity field 220 includes the entity that will process the payment transaction 222. In some embodiments, each field is included for each payment transaction record 222 in customer payment database 128. Various example payment transaction records 222 are shown in FIG. 2. Transaction record 222a refers to a payment transaction processed by a default payment network (Companynetwork). Transaction records 222b-222d refer to payment transactions processed by alternative processing entities (enterprise 118 and ACH network).

Modifications, additions, or omissions may be made to customer payment database 128. For example, customer payment database 128 may include transactions from any suitable number of enterprises 118. As another example, any suitable component within system 100 may include customer payment database 128. For example, customer database 132 may include customer payment database 128 for transactions involving customer accounts. In some embodiments, payment transaction module (or other component of enterprise 118) may include a merchant payment database (not explicitly shown) that may contain information similar to that stored in customer payment database 128. In some embodiments, the merchant payment database may store transactions involving merchant accounts associated with the enterprise.

FIG. 3 illustrates a particular embodiment of mobile payment application module 120 of system 100 of FIG. 1. Mobile payment application module 120 includes one or more interfaces 302, one or more processors 304, one or more memories 306, and merchant database 134 that collectively facilitate alternative payment processing of a payment transaction between a customer and a merchant that originates at a mobile device 114m. Memory 306 includes mobile payment logic 136.

Network interface 302 represents any suitable device operable to receive information from network 116, transmit information through network 116, perform processing of information, communicate with other devices, or any combination of the preceding. For example, network interface 302 receives payment transactions involving customer accounts and merchant accounts. As another example, network interface 302 may communicate payment transaction results and payment transaction rules to network 116 and/or payment devices 114. As another example, network interface 302 may communicate with a service that facilitates processing of payment transactions originating from mobile devices such as 114m. Network interface 302 represents any port or connection, real or virtual, including any suitable hardware and/or software, including protocol conversion and data processing capabilities, to communicate through a LAN, WAN, or other communication system that allows mobile payment application module 120 to exchange information with enterprise 118, network 116, computers 112, payment devices 114, or other components of system 100.

Processor 304 communicatively couples to network interface 302 and memory 306 and controls the operation and administration of mobile payment application module 120 by processing information received from network interface 302 and memory 306. Processor 304 includes any hardware and/or software that operates to control and process information. For example, processor 304 executes mobile payment logic 136 to control the operation of mobile payment application module 120. Processor 304 may be a programmable logic device, a microcontroller, a microprocessor, any suitable processing device, or any suitable combination of the preceding.

Memory 306 stores, either permanently or temporarily, data, operational software, or other information for processor 304. Memory 306 includes any one or a combination of volatile or non-volatile local or remote devices suitable for storing information. For example, memory 306 may include RAM, ROM, magnetic storage devices, optical storage devices, or any other suitable information storage device or a combination of these devices. In the illustrated embodiment, memory 306 includes mobile payment logic 136. Mobile payment logic 136 generally refers to logic, rules, algorithms, code, tables, and/or other suitable instructions embodied in a computer-readable storage medium for performing the described functions and operations of mobile payment application module 120. While illustrated as including a particular module, memory 306 may include any suitable information for use in the operation of mobile payment application module 120.

Merchant database 134 stores, either permanently or temporarily, account information for merchants that have accounts associated with enterprise 118. Mobile payment application module 120 may access merchant database 134 to determine whether a merchant account identifier corresponds to a merchant account associated with enterprise 118. In some embodiments, merchant database 134 stores identifying information for each merchant account associated with enterprise 118. For example, merchant database 134 may store a plurality of merchant account identifiers that each identify a particular merchant account associated with enterprise 118. A merchant account identifier may be any suitable identification means, such a numeric, alphabetical, alphanumeric, or symbolic value. Merchant database 134 includes any one or a combination of volatile or non-volatile local or remote devices suitable for storing information. For example, merchant database may include RAM, ROM, magnetic storage devices, optical storage devices, or any other suitable information storage device or combination of these devices.

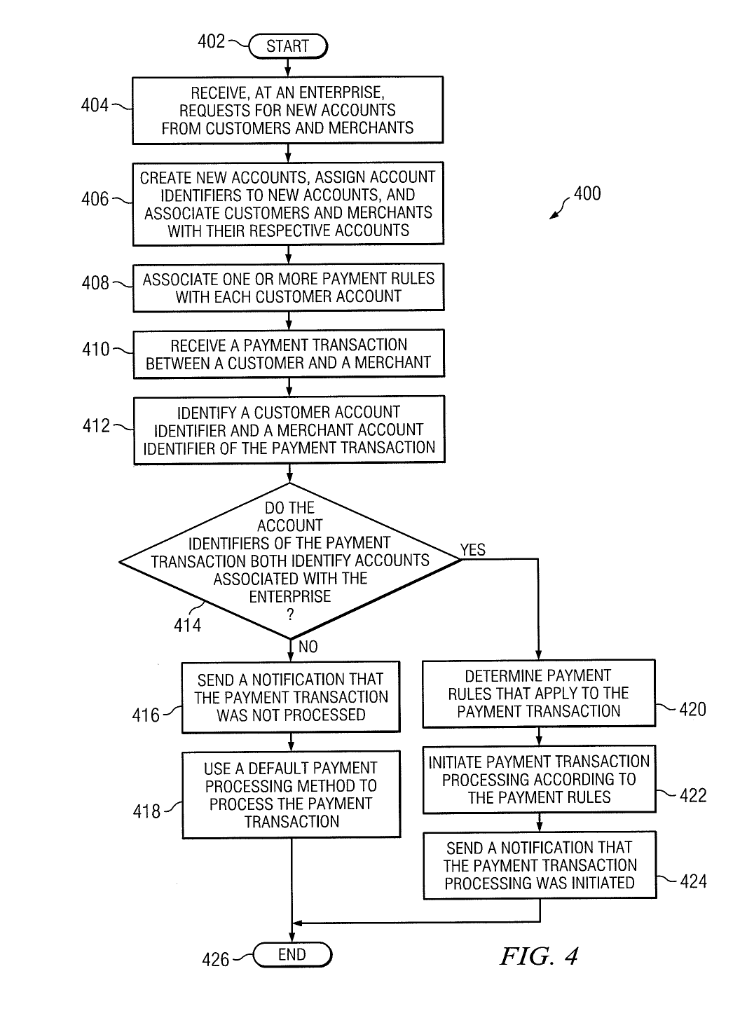

FIG. 4 illustrates an example method 400 for facilitating the processing of a payment transaction involving a merchant account and a customer account associated with the same enterprise 118. The method begins at step 402. At step 404, enterprise 118 receives requests for new accounts from customers and merchants. At step 406, enterprise 118 creates new accounts based on the requests received in step 404. Enterprise 118 also assigns account identifiers to the new accounts. For example, a customer account identifier may be assigned to an account associated with a customer. As another example, a merchant account identifier may be assigned to an account associated with a merchant.

At step 408, enterprise 118 associates payment rule sets 224 with customer accounts. A rule set 224 may include one or more criteria for processing a payment transaction that involves the customer. In some embodiments, enterprise 118 may also associate rule sets 226 with merchant accounts. At step 410, a payment transaction between a customer and a merchant is received at enterprise 118. At step 412, enterprise 118 identifies a customer account identifier and a merchant account identifier of the payment transaction. At step 414, enterprise 118 determines whether the customer account identifier and the merchant account identifier correspond to respective accounts associated with enterprise 118. In some embodiments, if the customer account identifier does not correspond to a customer account associated with the enterprise, then enterprise 118 does not determine whether the merchant account identifier corresponds to a merchant account associated with the enterprise. Similarly, in some embodiments, if the merchant account identifier does not correspond to a merchant account associated with the enterprise, then enterprise 118 does not determine whether the customer account identifier corresponds to a customer account associated with the enterprise.

If the customer account identifier and the merchant account identifier do not each correspond to respective accounts associated with enterprise 118, the method moves to step 416. At step 416, enterprise 118 sends a notification that the payment transaction was not processed. The notification may be sent to mobile payment application module 120, network 116, and/or the payment device 114 that sent the payment transaction to enterprise 118. At step 418, a default method of payment processing is performed. For example, payment device 114 or network 116 may send the payment transaction to a default payment network for payment processing.

If it is determined at step 414 that the customer account identifier and the merchant account identifier each correspond to respective accounts associated with enterprise 118, the method moves to step 420. At step 420, enterprise 118 determines one or more payment transaction rules that apply to the payment transaction. For example, payment transaction module 124 of enterprise 118 may access transaction rules database 127 and determine one or more payment transaction rules that apply based on information included in the payment transaction and/or stored by enterprise 118.

At step 422, enterprise 118 initiates the processing of the payment transaction according to the payment rules identified in step 420. For example, enterprise 118 may process the transaction. As another example, enterprise 118 may send the payment transaction, information included in the payment transaction, and/or payment transaction rules to another alternative processing entity, such as the ACH network, to process the payment transaction. At step 424, enterprise 118 sends a notification that the payment transaction was processed. For example, the notification may be sent to network 116, payment device 114, and/or mobile payment application module 120. The method ends at step 426.

Modifications, additions, or omissions may be made to method 400. The method may include more, fewer, or other steps. Additionally, steps may be performed in parallel or in any suitable order. Any suitable component of system 100 may perform one or more steps of method 400.

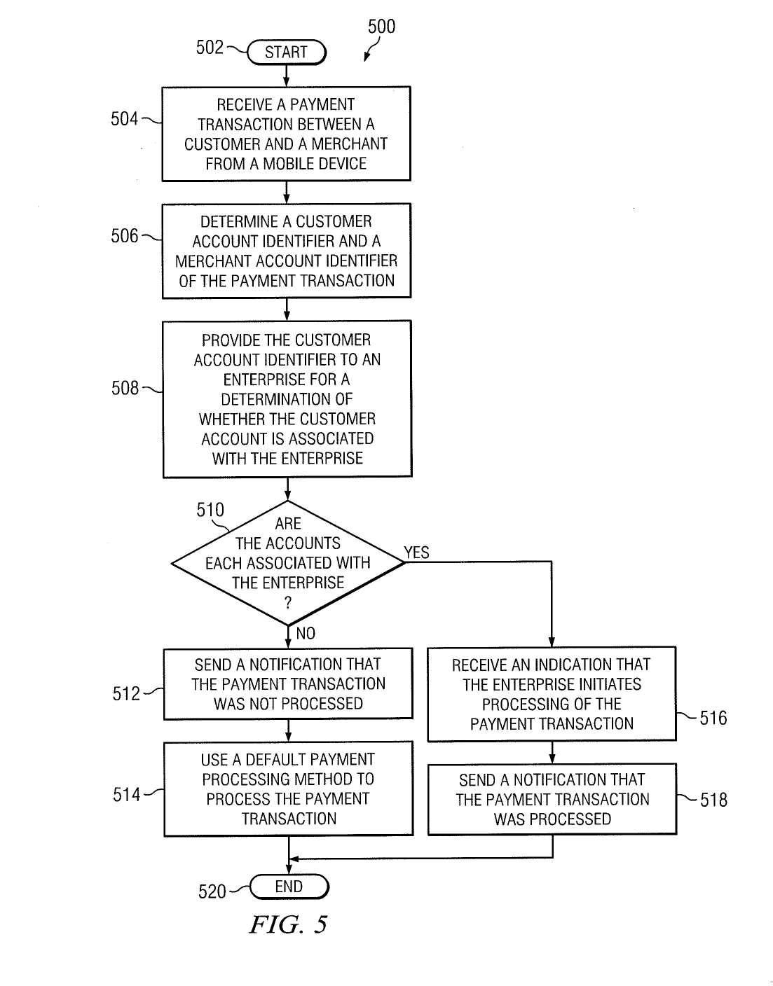

FIG. 5 illustrates an example method 500 for facilitating the processing of a payment transaction originating from a mobile device. The method begins at step 502. At step 504, mobile payment application module 120 receives a payment transaction between a customer and a merchant from a payment device 114m (e.g., a mobile device coupled to a card reading apparatus 122). The payment transaction may originate at payment device 114m. For example, the payment transaction may be initiated by a customer swiping a card 123 through card reading apparatus 122 coupled to payment device 114m. In some embodiments, mobile application module 120 may receive the payment transaction from an entity that facilitates payment processing on behalf of a plurality of mobile devices that each use a card reading apparatus similar to (e.g., of the same brand as) card reading apparatus 122.

At step 506, mobile payment application module 120 determines a customer account identifier and a merchant account identifier of the payment transaction. For example, mobile payment application module 120 may extract the customer account identifier and merchant account identifier from the payment transaction.

At step 508, mobile payment application 120 provides the customer account identifier to an enterprise 118 for a determination of whether the customer account is associated with the enterprise 118. In some embodiments, mobile payment application module 120 may also communicate the merchant account identifier to enterprise 118 for use by the enterprise in determining whether the merchant account identifier corresponds to a merchant account associated with enterprise 118. In other embodiments, mobile payment application module 120 may determine whether the merchant account identifier corresponds to a merchant account associated with enterprise 118. For example, mobile payment application module 120 may access merchant database 134 to determine whether the merchant account identifier corresponds to a merchant account associated with enterprise 118.

At step 510, enterprise 118 determines whether the customer account identifier and the merchant account identifier both correspond to respective accounts associated with enterprise 118. For example, enterprise 118 may access customer database 132 to determine whether the customer account identifier received from mobile payment application module 120 corresponds to a customer account associated with enterprise 118. Similarly, enterprise 118 may access merchant database 130 to determine whether the merchant account identifier received from mobile payment application module 120 corresponds to a merchant account associated with enterprise 118. In other embodiments, enterprise 118 may rely on a determination by mobile payment application module 120 that the merchant account identifier of the payment transaction corresponds to a merchant account associated with enterprise 118.

If, at step 510, it is determined that the customer account identifier and the merchant account identifier do not both correspond to respective accounts associated with enterprise 118, the method moves to step 512. At step 512, the mobile payment application module 120 sends a notification that the payment transaction was not processed. In some embodiments, mobile payment application module 120 may receive an indication from enterprise 118 that the enterprise will not facilitate (e.g., cause) the payment transaction processing before mobile payment application module 120 sends the notification. In some embodiments, mobile payment application module 120 may send the notification that the payment transaction was not processed to payment device 114m, network 116, and/or an entity that facilitates payment processing on behalf of a plurality of mobile devices that each use a card reading apparatus similar to card reading apparatus 122.

At step 514, a default payment processing method is used to process the payment transaction. For example, mobile payment device 114m, network 116, mobile payment application module 120, or an entity that facilitates payment processing on behalf of a plurality of mobile devices that each use a card reading apparatus similar to card reading apparatus 122 may send the payment transaction to a default network for payment processing.

If, at step 510, it is determined that the customer account identifier and the merchant account identifier both correspond to respective accounts associated with enterprise 118, the method moves to step 516. At step 516, the mobile payment application module 120 receives an indication that enterprise 118 initiates the processing of the payment transaction. For example, mobile payment application module 120 may receive an indication that enterprise 118 will process (or already has processed) the payment transaction. As another example, mobile payment application module 120 may receive an indication that enterprise 118 has instructed (or will instruct) an alternative processing entity to process the payment transaction. As another example, enterprise 118 may instruct mobile payment application module 120 to instruct an alternative processing entity to process the payment transaction. In some embodiments, mobile payment application module 120 may also receive payment transaction rules for processing the payment transaction from enterprise 118 and may forward these rules to the alternative processing entity. The method ends at step 520.

Modifications, additions, or omissions may be made to method 500. The method may include more, fewer, or other steps. Additionally, steps may be performed in parallel or in any suitable order. Any suitable component of system 100 may perform one or more steps of method 500.

Certain embodiments of the invention may provide one or more technical advantages. A technical advantage of one embodiment includes using a payment transaction module to determine whether a customer account and a merchant account involved in a payment transaction are associated with the same enterprise. Another advantage includes performing alternative payment processing for a payment transaction if the merchant account and customer account are associated with the same enterprise. Another advantage includes using a method of payment processing that is cheaper and/or faster than a default payment processing method.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

1. An apparatus, comprising:
a network interface operable to:
receive, at an enterprise from a network, a payment transaction comprising a customer account identifier and a merchant account identifier; and
a processing device in communication with the network interface, the processing device operable to:
determine whether the customer account identifier corresponds to a customer account associated with the enterprise;
determine whether the merchant account identifier corresponds to a merchant account associated with the enterprise;
if the customer account identifier and the merchant account identifier each correspond to a respective account associated with the enterprise:
initiate, at the enterprise, the processing of the payment transaction if both the customer account identifier and the merchant account identifier each correspond to a respective account associated with the enterprise; and
send a notification through the interface that the enterprise initiates the processing of the payment transaction; and
if the customer account identifier and the merchant account identifier do not each correspond to a respective account associated with the enterprise, send a notification through the interface that the payment transaction was not processed.

2. The apparatus of claim 1, wherein the processing device is further operable to initiate the processing of the payment transaction by initiating a book transfer, the book transfer comprising crediting, by the enterprise, the corresponding merchant account and debiting the corresponding customer account.

3. The apparatus of claim 1, wherein the processing device is further operable to initiate the processing of the payment transaction by communicating the customer account identifier and the merchant account identifier to an Automated Clearinghouse (ACH) Network.

4. The apparatus of claim 1, wherein the sending a notification through the interface that the enterprise initiates the processing of the payment transaction comprises an element chosen from a group comprising:
sending a notification that the enterprise has initiated the processing of the payment transaction; and
sending a notification that the enterprise will initiate the processing of the payment transaction.

5. The apparatus of claim 1, wherein the processing device is further operable to:
identify one or more payment rules associated with the customer account that corresponds to the customer account identifier; and
process the payment transaction according to the one or more payment rules.

6. The apparatus of claim 5, the one or more payment rules comprising a discount that a customer associated with the enterprise receives for purchasing from a merchant that is also associated with the enterprise.

7. The apparatus of claim 5, the one or more payment rules comprising a cash back amount that a customer associated with the enterprise receives for purchasing from a merchant that is also associated with the enterprise.

8. The apparatus of claim 1, wherein the enterprise comprises a plurality of financial institutions that are each capable of processing the payment transaction if the customer account and the merchant are associated with at least one of the plurality of financial institutions.

9. The apparatus of claim 1, wherein:
the payment transaction is initiated by a payment module associated with a payment processing entity; and
the payment network is associated with the payment processing entity.

10. A non-transitory computer readable medium comprising logic, the logic, when executed by a computer, operable to:
receive, at an enterprise from a network, a payment transaction comprising a customer account identifier and a merchant account identifier;
determine whether the customer account identifier corresponds to a customer account associated with the enterprise;
determine whether the merchant account identifier corresponds to a merchant account associated with the enterprise;
if the customer account identifier and the merchant account identifier each correspond to a respective account associated with the enterprise:
initiate, at the enterprise, the processing of the payment transaction if both the customer account identifier and the merchant account identifier each correspond to a respective account associated with the enterprise; and
send a notification that the enterprise initiates the processing of the payment transaction; and
if the customer account identifier and the merchant account identifier do not each correspond to a respective account associated with the enterprise, sending a notification that the payment transaction was not processed.

11. The computer readable medium of claim 10, the logic further operable to initiate the processing of the payment transaction by initiating a book transfer, the book transfer comprising crediting the corresponding merchant account and debiting the corresponding customer account.

12. The computer readable medium of claim 10, wherein the enterprise comprises a plurality of financial institutions that are each capable of processing the payment transaction if the customer account and the merchant are associated with at least one of the plurality of financial institutions.

13. A method, comprising:
receiving, at an enterprise from a network, a payment transaction comprising a customer account identifier and a merchant account identifier;
determining, by a processing device, whether the customer account identifier corresponds to a customer account associated with the enterprise;
determining, by the processing device, whether the merchant account identifier corresponds to a merchant account associated with the enterprise;
if the customer account identifier and the merchant account identifier each correspond to a respective account associated with the enterprise:
initiating, by the processing device, the processing of the payment transaction if both the customer account identifier and the merchant account identifier each correspond to a respective account associated with the enterprise; and
sending, by the processing device, a notification that the enterprise initiates the processing of the payment transaction; and
if the customer account identifier and the merchant account identifier do not each correspond to a respective account associated with the enterprise, sending, by the processing device, a notification that the payment transaction was not processed.

14. The method of claim 13, the initiating the processing of the payment transaction further comprising initiating a book transfer, the book transfer comprising crediting the corresponding merchant account and debiting the corresponding customer account.

15. The method of claim 13, the initiating the processing of the payment transaction further comprising communicating the customer account identifier and the merchant account identifier to an Automated Clearinghouse (ACH) network.

16. The method of claim 13, the sending a notification that the enterprise initiates the processing of the payment transaction comprising an element chosen from a group comprising:
sending a notification that the enterprise has initiated the processing of the payment transaction; and
sending a notification that the enterprise will initiate the processing of the payment transaction.

17. The method of claim 13, the initiating the processing of the payment further comprising:
identifying one or more payment rules associated with the customer account that corresponds to the customer account identifier; and
causing the payment transaction to be processed according to the one or more payment rules.

18. The method of claim 17, the one or more payment rules comprising a discount that a customer associated with the enterprise receives for purchasing from a merchant that is also associated with the enterprise.

19. The method of claim 17, the one or more payment rules comprising a first cash back amount that a customer associated with the enterprise receives for purchasing from a merchant that is also associated with the enterprise.

20. The method of claim 13, wherein the enterprise comprises a plurality of financial institutions that are each capable of processing the payment transaction if the customer account and the merchant are associated with at least one of the plurality of financial institutions.

21. The method of claim 13, wherein:
the payment transaction is initiated by a payment module associated with a payment processing entity; and
the payment network is associated with the payment processing entity.

22. The method of claim 13, wherein:
initiating, at the enterprise, the processing of the payment transaction comprises bypassing of processing of the payment transaction by a default payment network that is different from the enterprise network if both the customer account identifier and the merchant account identifier each correspond to a respective account associated with the enterprise; and
sending the notification through the interface that the payment transaction was not processed comprises sending a notification that the payment transaction will be processed by the default payment network that is different from the enterprise network if the customer account identifier and the merchant account identifier do not each correspond to a respective account associated with the enterprise.

23. The apparatus of claim 1, wherein
initiating, at the enterprise, the processing of the payment transaction comprises bypassing of processing of the payment transaction by a default payment network that is different from the enterprise network if both the customer account identifier and the merchant account identifier each correspond to a respective account associated with the enterprise; and
sending the notification through the interface that the payment transaction was not processed comprises sending a notification that the payment transaction will be processed by the default payment network that is different from the enterprise network if the customer account identifier and the merchant account identifier do not each correspond to a respective account associated with the enterprise.

24. The computer readable medium of claim 10, wherein:
initiating, at the enterprise, the processing of the payment transaction comprises bypassing of processing of the payment transaction by a default payment network that is different from the enterprise network if both the customer account identifier and the merchant account identifier each correspond to a respective account associated with the enterprise; and
sending the notification through the interface that the payment transaction was not processed comprises sending a notification that the payment transaction will be processed by the default payment network that is different from the enterprise network if the customer account identifier and the merchant account identifier do not each correspond to a respective account associated with the enterprise.
